(19) United States
(12) Patent Application Publication
(10) Pub. No.: US 2012/0163205 A1
(43) Pub. Date: Jun. 28, 2012

(54) SYSTEM AND METHOD FOR FLOW CONTROL IN A MULTI-POINT HSDPA COMMUNICATION NETWORK

(75) Inventors: Danlu Zhang, San Diego, CA (US); Sharad Deepak Sambhwani, San Diego, CA (US); Rohit Kapoor, San Diego, CA (US); Jilei Hou, San Diego, CA (US); Weiyan Ge, San Diego, CA (US)

(73) Assignee: QUALCOMM INCORPORATED, San Diego, CA (US)

(21) Appl. No.: 13/170,064

(22) Filed: Jun. 27, 2011

Related U.S. Application Data
(60) Provisional application No. 61/359,326, filed on Jun. 28, 2010.
(60) Provisional application No. 61/374,212, filed on Aug. 16, 2010.
(60) Provisional application No. 61/477,776, filed on Apr. 21, 2011.
(60) Provisional application No. 61/483,020, filed on May 5, 2011.

(51) Int. Cl. H04W 28/02; H04W 72/10; H04W 72/04

(52) U.S. Cl. 370/252; 370/329

(57) ABSTRACT

A base station (e.g., a Node B in a Multi-Point HSDPA network) calculates an amount of data to request from a network node (e.g., a radio network controller or RNC). As a part of the algorithm utilized, a length of a queue at the Node B for buffering the flow may be dynamically adjusted in an effort to optimize the trade-off between buffer underrun and skew. Further, a network node (e.g., the RNC) responds to Node B flow control requests. Here, the RNC may determine the amount of data to send to the Node B in response to the flow control message from the Node B, and may send the data to the Node B. In various aspects of the present disclosure involving a Multi-Point HSDPA system, the flow control algorithm at the RNC coordinates packet flow to the primary serving cell and the secondary serving cell for the UE.

### CROSS-REFERENCE TO RELATED APPLICATIONS

This application claims priority to and the benefit of provisional patent application No. 61/359,326, filed in the United States Patent and Trademark Office on Jun. 28, 2010; provisional patent application No. 61/374,212, filed in the United States Patent and Trademark Office on Aug. 16, 2010; provisional patent application No. 61/477,776, filed in the United States Patent and Trademark Office on Apr. 21, 2011; and provisional patent application No. 61/483,020 filed in the United States Patent and Trademark Office on May 5, 2011, the entire contents of which are incorporated herein by reference.

### BACKGROUND

1. Field

Aspects of the present disclosure relate generally to wireless communication systems, and more particularly, to flow control algorithms for managing packets sent over a downlink for aggregation.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

As an example, Multi-Point HSDPA has been recently introduced, in which plural cells can provide high-speed downlink communication to a mobile station, such that the mobile station is capable of aggregating the transmissions from those cells, within the same frequency carrier. As a relatively new system, various issues arise in this system that may not have been addressed in other downlink aggregation systems such as DC-HSDPA. Thus, there is a need to identify and address issues relating to system-level architecture, packet flow control, mobility, and others.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure, nor to delineate the scope of any or all aspects of the disclosure. Its sole purpose is to present some concepts of one or more aspects of the disclosure in a simplified form as a prelude to the more detailed description that is presented later.

Some aspects of the present disclosure provide a method, apparatus, and computer program product for a base station (e.g., a Node B in a Multi-Point HSDPA network) to calculate an amount of data to request from a network node (e.g., a radio network controller or RNC). As a part of the algorithm utilized, a length of a queue at the Node B for buffering the flow may be dynamically adjusted in an effort to optimize the trade-off between buffer underrun and skew.

Further aspects of the present disclosure provide a method, apparatus, and computer program product for a network node (e.g., the RNC) to respond to Node B flow control requests. Here, the RNC may determine the amount of data to send to the Node B in response to the flow control message from the Node B, and may send the data to the Node B. In various aspects of the present disclosure involving a Multi-Point HSDPA system, the flow control algorithm at the RNC coordinates packet flow to the primary serving cell and the secondary serving cell for the UE.

In one aspect, the disclosure provides a method of wireless communication that includes determining an estimated throughput of a flow from a Node B to a UE, selecting a target length of a queue for the flow at the Node B in accordance with the estimated throughput of the flow, such that a target queuing delay is maintained within a predetermined range, and requesting an amount of RLC data to be allocated to a MAC entity corresponding to the Node B.

Another aspect of the disclosure provides a method of wireless communication that includes receiving a first request from a first MAC entity for a first amount of RLC data corresponding to an RLC flow for a UE, and a second request from a second MAC entity for a second amount of the RLC data, allocating a first portion of the RLC data to the first MAC entity based in part on the first request, and based in part on a priority of the first MAC entity, and allocating a second portion of the RLC data to the second MAC entity based in part on the second request, and based in part on a priority of the second MAC entity.

Yet another aspect of the disclosure provides an apparatus for wireless communication that includes means for determining an estimated throughput of a flow from a Node B to a UE, means for selecting a target length of a queue for the flow at the Node B in accordance with the estimated throughput of the flow, such that a target queuing delay is maintained within a predetermined range, and means for requesting an amount of RLC data to be allocated to a MAC entity corresponding to the Node B.

Still another aspect of the disclosure provides an apparatus for wireless communication that includes means for receiving a first request from a first MAC entity for a first amount of RLC data corresponding to an RLC flow for a UE, and a second request from a second MAC entity for a second amount of the RLC data, means for allocating a first portion of the RLC data to the first MAC entity based in part on the first request, and based in part on a priority of the first MAC entity, and means for allocating a second portion of the RLC data to the second MAC entity based in part on the second request, and based in part on a priority of the second MAC entity.

Still another aspect of the disclosure provides an apparatus for wireless communication that includes a processing system and a memory coupled to the processing system. Here, the processing system is configured to determine an estimated throughput of a flow from a Node B to a UE, to select a target length of a queue for the flow at the Node B in accordance with the estimated throughput of the flow, such that a target queuing delay is maintained within a predetermined range, and to request an amount of RLC data to be allocated to a MAC entity corresponding to the Node B.

Still another aspect of the disclosure provides an apparatus for wireless communication that includes a processing system and a memory coupled to the processing system. Here, the processing system is configured to receive a first request from a first MAC entity for a first amount of RLC data corresponding to an RLC flow for a UE, and a second request from a second MAC entity for a second amount of the RLC data, to allocate a first portion of the RLC data to the first MAC entity based in part on the first request, and based in part on a priority of the first MAC entity, and to allocate a second portion of the RLC data to the second MAC entity based in part on the second request, and based in part on a priority of the second MAC entity.

Still another aspect of the disclosure provides a computer program product that includes a computer-readable medium having instructions for causing a computer to determine an estimated throughput of a flow from a Node B to a UE, instructions for causing a computer to select a target length of a queue for the flow at the Node B in accordance with the estimated throughput of the flow, such that a target queuing delay is maintained within a predetermined range, and instructions for causing a computer to request an amount of RLC data to be allocated to a MAC entity corresponding to the Node B.

Still another aspect of the disclosure provides a computer program product that includes a computer-readable medium having instructions for causing a computer to receive a first request from a first MAC entity for a first amount of RLC data corresponding to an RLC flow for a UE, and a second request from a second MAC entity for a second amount of the RLC data, instructions for causing a computer to allocate a first portion of the RLC data to the first MAC entity based in part on the first request, and based in part on a priority of the first MAC entity, and instructions for causing a computer to allocate a second portion of the RLC data to the second MAC entity based in part on the second request, and based in part on a priority of the second MAC entity.

To the accomplishment of the foregoing and related ends, the one or more aspects of the disclosure described herein may include the features hereinafter fully described and particularly pointed out in the claims. The following description and the annexed drawings set forth in detail certain illustrative features of the one or more aspects of the disclosure. These features are indicative, however, of but a few of the various ways in which the principles of various aspects of the disclosure may be employed, and this description is intended to include all such aspects of the disclosure, and their equivalents.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a conceptual diagram illustrating some of the layers utilized in a downlink path in an HSDPA network between an RNC and a UE.

FIG. 6 is a schematic diagram illustrating a portion of a multi-point HSDPA network.

FIG. 7 is a conceptual diagram illustrating some of the layers utilized in a downlink path in a multi-point HSDPA network between an RNC having a multi-link RLC layer and a UE.

FIG. 8 is a call flow diagram illustrating a simplified flow control process between an RNC and a pair of Node Bs operating in a Multi-Point HSDPA system.

FIG. 9 is a flow chart illustrating an exemplary process of generating a flow control message from a Node B.

FIG. 10 is a chart illustrating a relationship between a queuing time and a throughput.

FIG. 11 is a flow chart illustrating an exemplary process of controlling a target queue length in accordance with buffer underrun.

FIG. 12 is a flow chart illustrating an exemplary process of responding to a flow control message at an RNC.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Here, “medium” may include any media that facilitates transfer of a computer program from one place to another. As an example, the software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

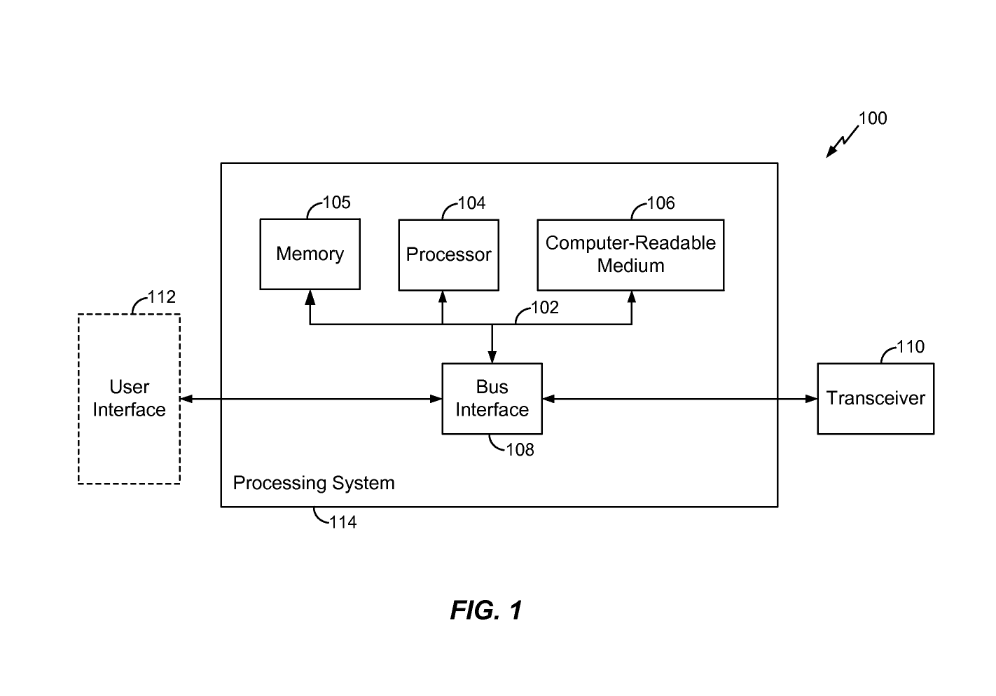

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, a memory 105, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

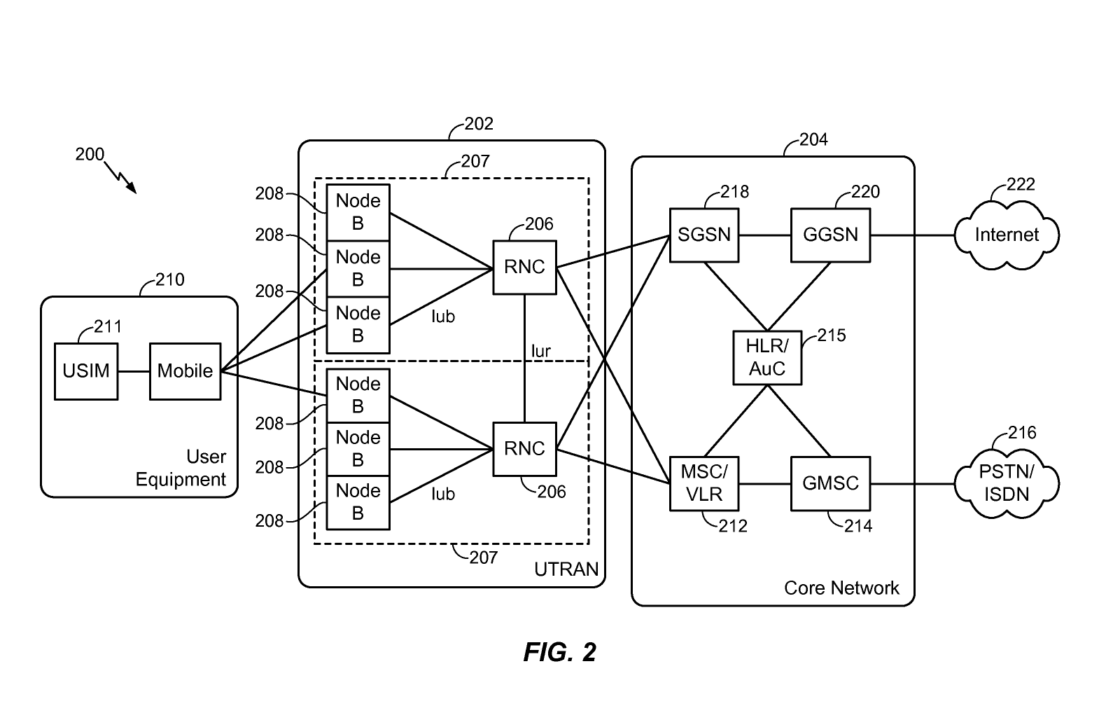

The various concepts presented throughout this disclosure may be implemented across a broad variety of telecommunication systems, network architectures, and communication standards. By way of example and without limitation, the aspects of the present disclosure illustrated in FIG. 2 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 may provide various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

A high speed packet access (HSPA) air interface includes a series of enhancements to the 3G/W-CDMA air interface between the Node B 208 and the UE 210, facilitating greater throughput and reduced latency. Among other modifications over prior releases, HSPA utilizes hybrid automatic repeat request (HARM), shared channel transmission, and adaptive modulation and coding. The standards that define HSPA include HSDPA (high speed downlink packet access) and HSUPA (high speed uplink packet access, also referred to as enhanced uplink, or EUL).

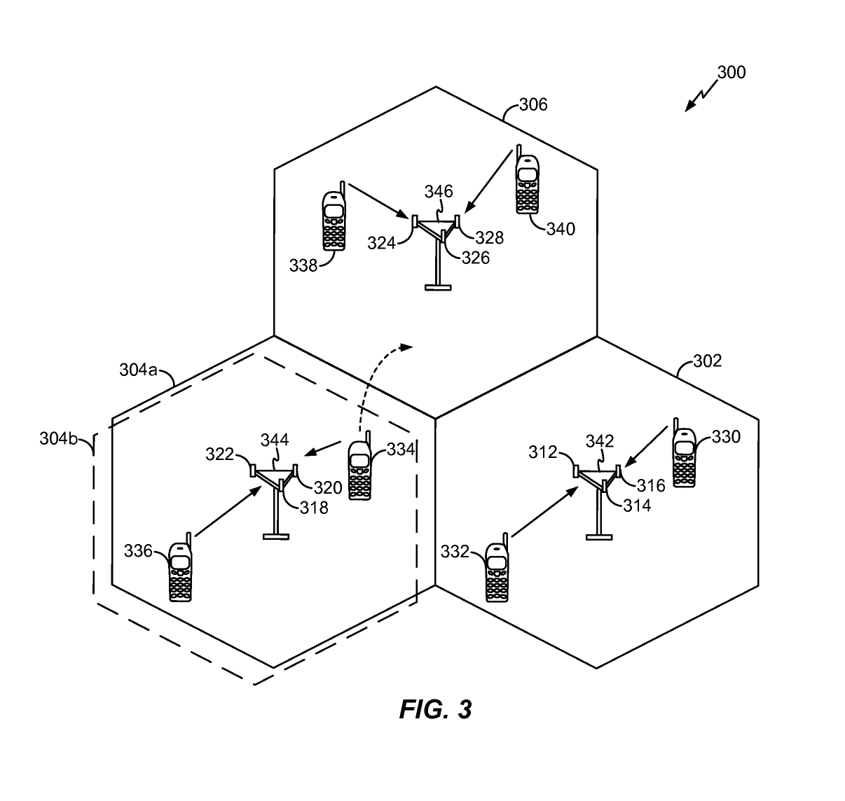

FIG. 3 illustrates by way of example and without limitation a simplified access network 300 in a UMTS Terrestrial Radio Access Network (UTRAN) architecture, which may utilize HSPA. The system includes multiple cellular regions (cells), including cells 302, 304, and 306, each of which may include one or more sectors. Cells may be defined geographically, e.g., by coverage area, and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within the cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector.

The cells 302, 304 and 306 may include several UEs that may be in communication with one or more sectors of each cell 302, 304 or 306. For example, UEs 330 and 332 may be in communication with Node B 342, UEs 334 and 336 may be in communication with Node B 344, and UEs 338 and 340 may be in communication with Node B 346. Here, each Node B 342, 344, 346 is configured to provide an access point to a core network 204 (see FIG. 2) for all the UEs 330, 332, 334, 336, 338, 340 in the respective cells 302, 304, and 306.

In Release 5 of the 3GPP family of standards, High Speed Downlink Packet

Access (HSDPA) was introduced. One difference on the downlink between HSDPA and the previously standardized circuit-switched air-interface is the absence of soft-handover in HSDPA. This means that data is transmitted to the UE from a single cell called the HSDPA serving cell. As the user moves, or as one cell becomes preferable to another, the HSDPA serving cell may change.

In Rel. 5 HSDPA, at any instance a UE has one serving cell. According to mobility procedures defined in Rel. 5 of 3GPP TS 25.331, the Radio Resource Control (RRC) signaling messages for changing the HSPDA serving cell are transmitted from the current HSDPA serving cell (i.e., the source cell), and not the cell that the UE reports as being the stronger cell (i.e., the target cell).

Further, with HSDPA the UE generally monitors and performs measurements of certain parameters of the downlink channel to determine the quality of that channel. Based on these measurements the UE can provide feedback to the Node B on an uplink transmission, such as a channel quality indicator (CQI). Thus, the Node B may provide subsequent packets to the UE on downlink transmissions having a size, coding format, etc., based on the reported CQI from the UE.

During a call with the source cell 304a, or at any other time, the UE 336 may monitor various parameters of the source cell 304a as well as various parameters of neighboring cells such as cells 304b, 306, and 302. Further, depending on the quality of these parameters, the UE 336 may maintain some level of communication with one or more of the neighboring cells. During this time, the UE 336 may maintain an Active Set, that is, a list of cells that the UE 336 is simultaneously connected to (i.e., the UTRA cells that are currently assigning a downlink dedicated physical channel DPCH or fractional downlink dedicated physical channel F-DPCH to the UE 336 may constitute the Active Set).

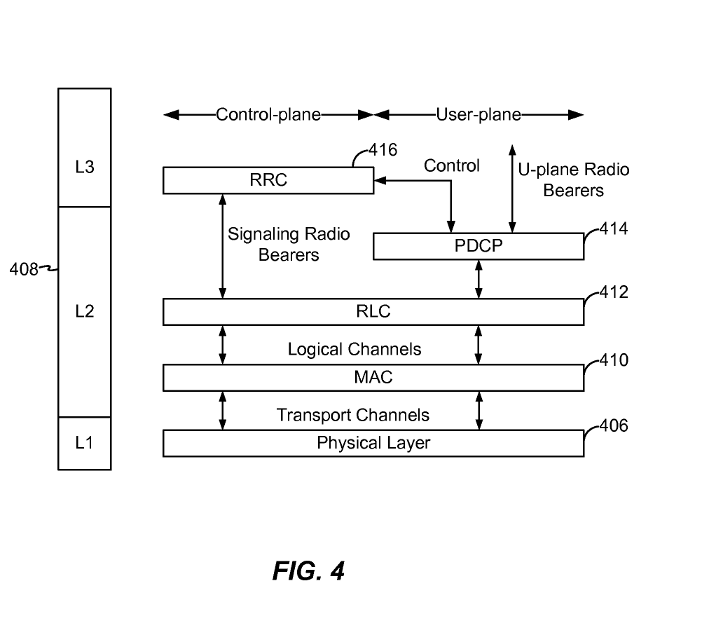

The radio protocol architecture between the UE and the UTRAN may take on various forms depending on the particular application. An example for an HSPA system will now be presented with reference to FIG. 4, illustrating an example of the radio protocol architecture for the user and control planes between a UE and a Node B. Here, the user plane or data plane carries user traffic, while the control plane carries control information, i.e., signaling.

Turning to FIG. 4, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 (L2 layer) 408 is above the physical layer 406 and is responsible for the link between the UE and Node B over the physical layer 406.

At Layer 3, the RRC layer 416 handles the control plane signaling between the

UE and the Node B. RRC layer 416 includes a number of functional entities for routing higher layer messages, handling broadcast and paging functions, establishing and configuring radio bearers, etc.

In the UTRA air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports acknowledged, unacknowledged, and transparent mode data transfers, and provides segmentation and reassembly of upper layer data packets, retransmission of lost data packets, and reordering of data packets to compensate for out-of-order reception due to a hybrid automatic repeat request (HARQ). That is, the RLC sublayer 412 includes a retransmission mechanism that may request retransmissions of failed packets. Here, if the RLC sublayer 412 is unable to deliver the data correctly after a certain maximum number of retransmissions or an expiration of a transmission time, upper layers are notified of this condition and the RLC SDU may be discarded.

Further, the RLC sublayer at the RNC 206 (see FIG. 2) may include a flow control function for managing the flow of RLC protocol data units (PDUs). For example, the RNC may determine an amount of data to send to a Node B, and may manage details of that allocation including dividing the data into batches and distributing those batches or packets among multiple Node Bs in the case of downlink aggregation, e.g., in a DC-HSDPA system or a Multi-Point HSDPA system.

The MAC sublayer 410 provides multiplexing between logical and transport channels. The MAC sublayer 410 is also responsible for allocating the various radio resources (e.g., resource blocks) in one cell among the UEs, as well as HARQ operations. The MAC sublayer 410 can include various MAC entities, including but not limited to a MAC-d entity and MAC-hs/ehs entity.

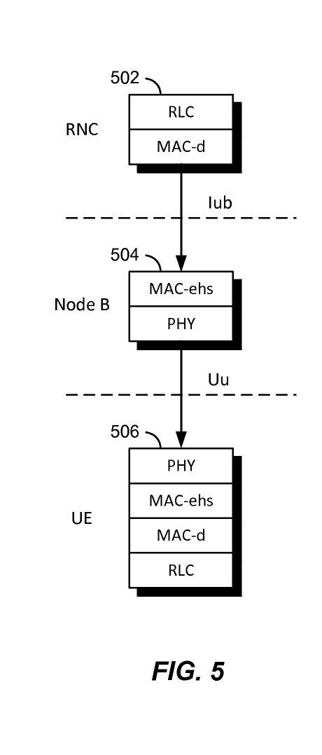

FIG. 5 is a schematic illustration of a downlink path in an HSDPA network between an RNC 502 and a UE 506, passing through a Node B 504, showing some of the sublayers at the respective nodes. Here, the RNC 502 may be the same as the RNC 206 illustrated in FIG. 2; the Node B 504 may be the same as the Node B 208 illustrated in FIG. 2; and the UE 506 may be the same as the UE 210 illustrated in FIG. 2. The RNC 502 houses protocol layers from MAC-d and above, including for example the RLC sublayer. For the high speed channels, a MAC-hs/ehs layer is housed in the Node B 504. Further a PHY layer at the Node B 504 provides an air interface for communicating with a PHY layer at the UE 506, e.g., over an HS-DSCH.

At the RNC 502, the RLC sublayer receives RLC SDUs from the core network, performs RLC-related functions such as segmentation, reassembly, and flow control, and provides RLC PDUs to the MAC-d sublayer. There is generally one MAC-d entity in the serving RNC for each UE. The MAC-d sublayer processes the packets and provides MAC PDUs over the Iub interface to the MAC-ehs entity at the Node B 504.

From the UE 506 side, a MAC-d entity is configured to control access to all the dedicated transport channels, to a MAC-c/sh/m entity, and to the MAC-hs/ehs entity. Further, from the UE 506 side, the MAC-hs/ehs entity is configured to handle the HSDPA specific functions and control access to the HS-DSCH transport channel. Upper layers configure which of the two entities, MAC-hs or MAC-ehs, is to be applied to handle HS-DSCH functionality.

Release 8 of the 3GPP standards brought dual cell HSDPA (DC-HSDPA), which enables a UE to aggregate dual adjacent 5-MHz downlink carriers. The dual carrier approach provides higher downlink data rates and better efficiency at multicarrier sites. Generally, DC-HSDPA utilizes a primary carrier and a secondary carrier, where the primary carrier provides the channels for downlink data transmission and the channels for uplink data transmission, and the secondary carrier provides a second set of HS-PDSCHs and HS-SCCHs for downlink communication.

According to some aspects of the present disclosure, another form of aggregation that may be referred to as soft aggregation provides for downlink aggregation, wherein the respective downlink cells utilize the same frequency carrier. Soft aggregation strives to realize similar gains to DC-HSDPA in a single-carrier network.

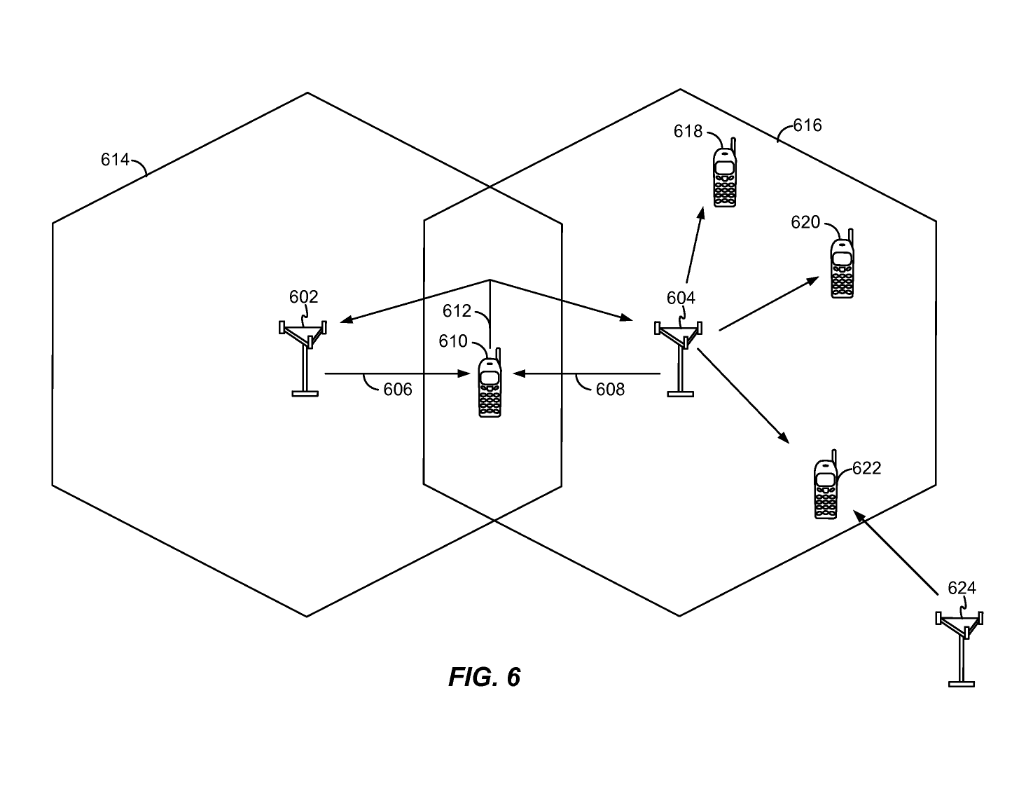

FIG. 6 illustrates an exemplary system for soft aggregation in accordance with some aspects of the present disclosure. In FIG. 6, there may be a geographic overlap between two or more cells 614 and 616, such that a UE 610 may be served, at least for a certain period of time, by the multiple cells. Thus, a wireless telecommunication system in accordance with the present disclosure may provide HSDPA service from a plurality of cells on a single frequency channel, such that a UE may perform aggregation. For example, a setup utilizing two or more cells may be referred to as Single Frequency Dual Cell HSDPA (SFDC-HSDPA), Coordinated Multi-Point HSDPA (CoMP HSDPA), or simply Multi-Point HSDPA. However, other terminology may freely be utilized. In this way, users at cell boundaries, as well as the overall system, may benefit from a high throughput. Here, the different cells may be provided by the same Node B, or the different cells may be provided by disparate Node Bs.

In the scheme illustrated in FIG. 6, two disparate Node Bs 602 and 604 each provide a downlink cell 606 and 608, respectively, wherein the downlink cells are in substantially the same carrier frequency. Of course, as already described, in another aspect, both downlink cells 606 and 608 may be provided from different sectors of the same Node B. Here, the UE 610 receives and aggregates the downlink cells and provides an uplink channel 612, which is received by both Node Bs 602 and 604. The uplink channel 612 from the UE 610 may provide feedback information, e.g., corresponding to the downlink channel state for the corresponding downlink cells 606 and 608.

A DC-HSDPA-capable UE has two receive chains, each of which may be used to receive HS data from a different carrier. In a Multi-Point HSDPA-capable UE 610, if the plural receive chains are made to receive HS data from different cells 614 and 616, at least some the benefits from aggregation can be realized in a single-carrier network.

In some aspects of the present disclosure, the two cells being aggregated may be restricted to cells in the UE's Active Set. These cells may be the strongest cells in the Active Set, determined in accordance with the downlink channel quality. If the aggregated cells reside in different Node B sites as illustrated in FIG. 6, this scheme may be called ‘soft aggregation’. If the aggregated cells reside in the same Node B site, this scheme may be called ‘softer aggregation.’

Softer aggregation is relatively straightforward to evaluate and implement. However, since the percentage of UEs in softer handover may be limited, the gain from softer aggregation may correspondingly be limited as well. On the other hand, soft aggregation has the potential to offer much greater benefit. However, there are concerns related to flow control at the RNC side as well as the Node B.

In a conventional DC-HSDPA system, or a Multi-Point HSDPA system wherein two cells are provided by a single Node B (i.e., softer aggregation), the two cells may share the same MAC-ehs entity in much the same way as the conventional HSDPA system illustrated in FIG. 5. Here, because the downlink data comes to the UE from a single Node B site, the RLC entity at the UE may generally assume that the packets are sent in order in accordance with their respective RLC sequence numbers. Thus, any gap in sequence numbers in received packets can be understood to be caused by a packet failure, and the RLC entity at the RNC may simply retransmit all packets corresponding to the missing sequence numbers.

However, in a Multi-Point HSDPA system wherein the cells are provided by disparate Node B sites (i.e., soft aggregation), the flow of packets from the RNC to the UE can result in gaps in sequence numbers as they are received by the UE for reasons other than packet failures. For example, depending on how a flow control algorithm distributes RLC PDUs to the respective Node Bs, the packets may arrive out of order at the UE, without necessarily implying any issues, since over time the packets may arrive as scheduled and fill the gaps. Such gaps caused by out-of-order delivery may be referred to as skew, to distinguish from transmission failures or otherwise lost packets.

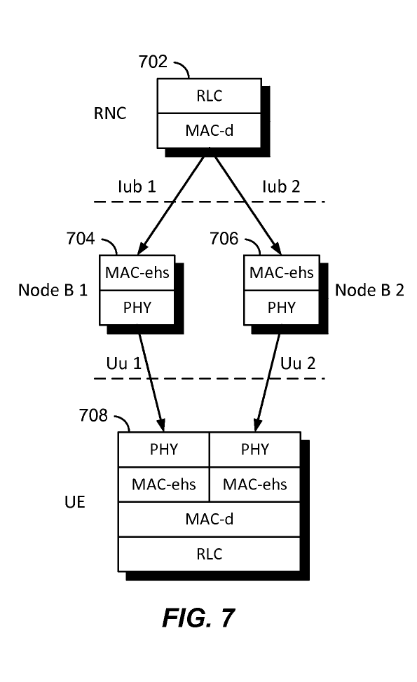

FIG. 7 is a schematic block diagram illustrating certain aspects of a Multi-Point

HSDPA system wherein the cells are provided by disparate Node B sites (i.e., soft aggregation). Here, an RNC 702 may include a multi-link RLC sublayer that provides packets to a plurality of Node Bs 704 and 706, which each provide downlink HS-transmissions to a UE 708. As compared to the scheme illustrated in FIG. 5, the RLC sublayer may be configured to include a flow control protocol for each priority queue of each UE 708. Here, the flow control protocol may coordinate the flow of packets to the UE 708 utilizing a queue at both Node Bs, in accordance with flow control messages from the Node Bs 704 and 706. In one example, the Node B 704 may act as a primary serving cell for the UE 708, and the Node B 706 may act as a secondary serving cell for the UE 708. Of course, the roles of the Node Bs 706 and 706 can be reversed as secondary and primary serving cells, respectively. In the exemplary Multi-Point HSDPA system, the Node Bs 704 and 706 receive the packets allocated to them by the RNC over respective Iub interfaces and transmit those packets to the UE 708 over air interfaces utilizing the same frequency channel.

Each Node B 704 and 706 includes a queue, or a buffer for temporarily storing the packets until they are transmitted to the UE 708. The queue may be any suitable structure for memory, including a storage space or any other non-random aggregation of data, irrespective of its particular mode of storage.

Here, the UE 708 may include a plurality of PHY layers, or in other words, a plurality of receive chains configured to receive the respective downlink transmissions from the Node Bs 704 and 706. Further, the UE 708 may include a plurality of corresponding MAC entities, each of the plurality of MAC entities corresponding to a different serving cell (e.g., a primary serving cell and a secondary serving cell) from corresponding Node B sites. For example, one MAC entity in the UE 708 may correspond to the first Node B 704 providing a primary serving cell, and a second MAC entity in the UE 708 may correspond to the second Node B 706 providing a secondary serving cell. Of course, for various reasons, the pairing of a particular MAC entity with a particular Node B may change over time, and the illustration is only one possible example.

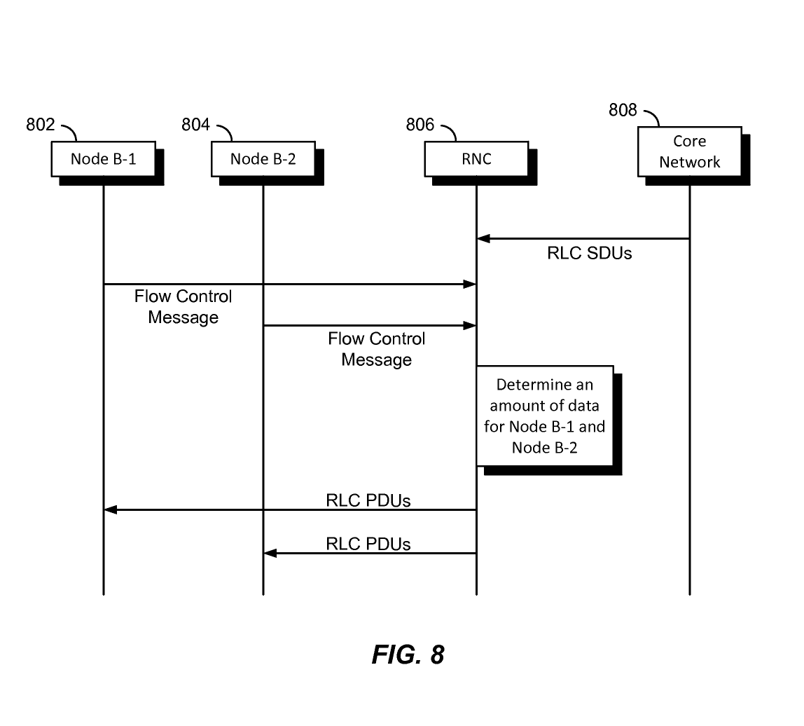

FIG. 8 is a simplified call flow diagram illustrating some of the signals utilized for flow control in a Multi-Point HSDPA system in accordance with some of the aspects of the present disclosure. Here, Node B-1 802 and Node B-2 804 serve as a primary serving cell and a secondary serving cell, respectively, for a certain UE (not illustrated for simplicity). The RNC 806 is coupled to each of the Node Bs 802 and 804 by way of respective Iub interfaces. Of course, other interfaces may be utilized within the scope of the present disclosure. Further, the RNC 806 is coupled to a core network 808, which may be a circuit-switched or packet-switched core network, or a combination of the two as illustrated in FIG. 2.

As illustrated, the RNC 806 receives RLC SDUs from the core network 808, directed to the UE being served by the Node Bs 802 and 804. Node B-1 802 and Node B-2 each generate and send a flow control message requesting data for the UE from the RNC 806. In response to the flow control messages from the Node Bs 802 and 804, the RNC 808 determines an amount of the RLC data to allocate to each of the Node Bs based on a number of factors, and sends the data as RLC PDUs to the Node Bs 802 and 804 over the respective Iub interfaces.

In some aspects of the present disclosure, the Node B may be the master of the flow control algorithm. That is, the Node B may grant buffer space to the RNC utilizing a flow control message. The flow control message may control an allocation size, an HS-DSCH interval, and an HS-DSCH repetition period.

Here, the allocation size includes the number of MAC-d PDUs to be allocated to the Node B for a particular flow, and the maximum size of those MAC-d PDUs. The HS-DSCH interval is a time interval over which the MAC-d PDUs may be sent to the Node B. The HS-DSCH repetition period is the period over which this allocation is refreshed and repeated. Of course, those skilled in the art will comprehend that the particular format of the flow control message may be altered yet still remain within the scope of the present disclosure, as described in further detail below.

In some examples in accordance with the present disclosure, separate flow control algorithms may be utilized at each Node B for managing data transmissions through the primary serving cell 802 and the secondary serving cell 804. Here, the flow control algorithm for the secondary serving cell 804 may be different than the flow control algorithm for the primary serving cell 802.

Further, the separate flow control algorithms at the respective Node Bs may coordinate with one another utilizing an information exchange between the Node Bs 802 and 804. For example, the exchange of information may coincide with the sending of the flow control message from the Node Bs 802 and 804 to the RNC 806, or may utilize any suitable interface between the respective serving cells 802 and 804 which may or may not include the RNC 806. In some aspects of the present disclosure, a parameter corresponding to the throughput of the flow from the respective Node B to the UE may be included in the information exchange, e.g., by being added to the flow control message sent to the RNC 806. This flexibility in flow control message signaling and separate algorithms at each Node B can provide a broad scope for flow control strategies.

A common issue faced by flow control algorithms is buffer underrun. Buffer underrun occurs when the input to a buffer is filling at a lower rate than an output from the buffer is emptying. Here, the buffer may become empty, causing the algorithm to need to pause or stop reading from the buffer as the buffer refills. Such a condition can cause various issues in a data stream, known to those skilled in the art and not described in the present disclosure.

As described above, each Node B may include a queue that may buffer packets before they are transmitted to the UE. One goal of a flow control algorithm may be to minimize buffer underrun at this queue. A straightforward way to reduce buffer underrun is to increase the length of the buffer. However, this may conflict with another goal of a flow control algorithm, which is to minimize the number of PDUs held at the Node B in order to reduce the difficulty in data recovery during handover, and to reduce the required Node B memory size. Thus, a comprehensive flow control algorithm may seek an optimum trade-off between these goals. In an aspect of the present disclosure, this trade-off can be managed by dynamically controlling a variable length of the buffer, as described in further detail below.

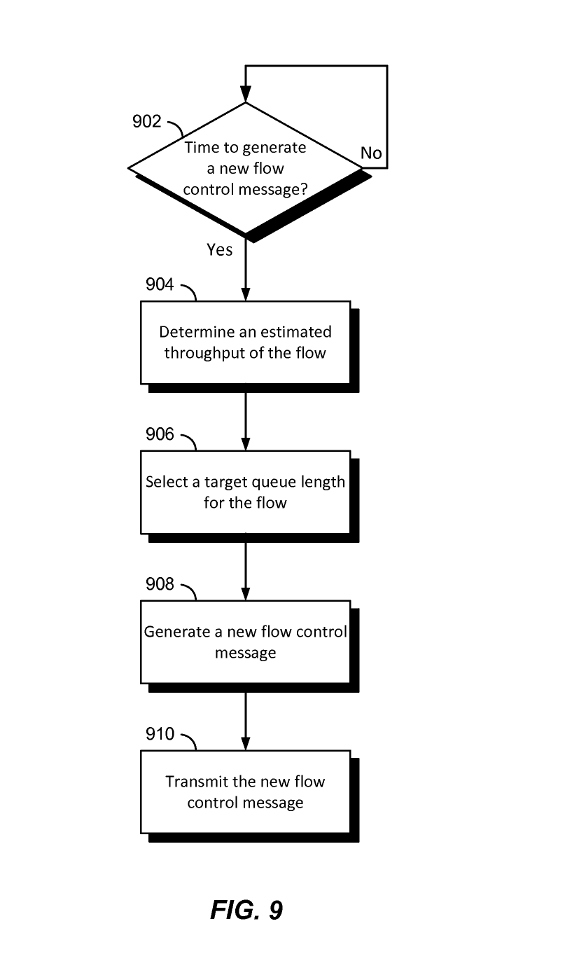

FIG. 9 is a flow chart illustrating some aspects of a flow control algorithm at a Node B. Here, the flow control algorithm may run at either a primary serving cell or a secondary serving cell. In block 902, the process may determine whether to generate a new flow control message to send to the RNC. If no, then the process may return to block 902, potentially after a suitable delay period. If the process determines to generate a new flow control message, then the process may proceed to block 904, wherein the Node B may determine an estimated throughput of a flow from the Node B to a UE, as described in further detail below. In block 906, the process may select a target queue length of the queue at the Node B corresponding to the flow, and update the target queue length with the selected value. Here, the target queue length may correspond to the estimated throughput of the flow determined in block 904. Further, the target queue length may be selected to maintain a target queuing delay within a predetermined range. Additional information regarding the selection of the target length of the queue for the flow is given in further detail below.

In block 908, the process may generate a new flow control message for requesting data from the RNC, and in block 910, the Node B may transmit the generated flow control message to the RNC over the Iub interface. Generally, the flow control message generated in block 908 includes a request for a certain amount of RLC data to be allocated to a MAC entity corresponding to the Node B (e.g., a MAC-ehs entity). Here, the Node B may calculate an amount of data to request in the flow control message. The amount of data the Node B requests may depend on a number of factors, including but not necessarily limited to: a target queue length for the flow, a current queue length for the flow, a priority of the MAC entity at the Node B, the status of the Node B as a primary serving cell or a secondary serving cell, and an amount of data for UEs other than the UE that are served by the Node B as a primary serving cell.

The relationship between the amount of data requested and the target queue length is generally due to the fact that the queue is where the data will temporarily be stored. As discussed above, in various aspects of the present disclosure the target queue length may dynamically be adapted based on several factors, and this in turn may affect the amount of data requested by the Node B.

In accordance with some aspects of the disclosure, the target queue length may be selected to maintain a target queuing delay within a range (e.g., a predetermined range). As one example, the range of the target queue length may be maintained between an upper and lower bound. In various particular implementations, the values of the upper bound and lower bound may be fixed (e.g., predetermined). In other implementations, one or both of the upper bound and the lower bound may vary based on various factors or parameters.

In accordance with an aspect of the present disclosure, the selection of the target queue length, or the upper bound on the queue length, may be based on an estimated throughput of the flow from the Node B to the UE that utilizes that queue. For example, the target queue length (in bits, or bytes) may be set as a product of the estimated throughput of the flow (in bits per second) and a target queuing time (in seconds) at the Node B.

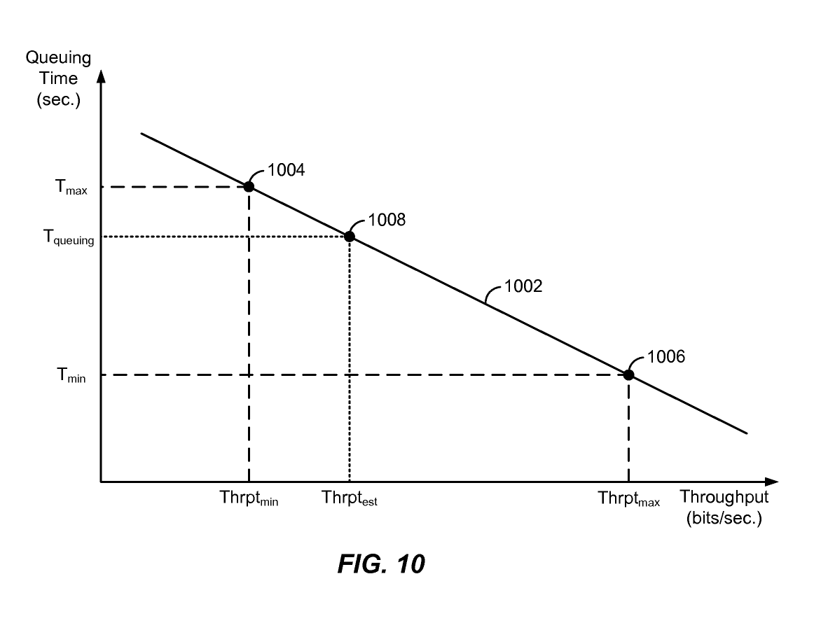

FIG. 10 is a simplified chart illustrating an exemplary relationship between the queuing time T for a flow, in seconds, and the throughput Thrpt of the flow, in bits per second. Here, the queuing time, or delay for the queue, may correspond to an amount of time that the information remains in the queue at the Node B before being transmitted to the UE. As illustrated, as the queuing time for the flow decreases, the throughput increases; and as the throughput decreases, the queuing time for the flow increases.

This relationship is a generally linear relationship, represented by the line 1002. Specifically, two points on the line are illustrated: a first point 1004 at (Thrptₘᵢₙ, Tₘₐₓ) and a second point 1006 at (Thrptₘₐₓ, Tₘᵢₙ).

In an aspect of the disclosure, a target queuing time T_{queuing} may be determined by estimating the throughput for the flow, Thrptₑₛₜ, and finding the point on the line 1002 corresponding to the estimated throughput. That is, the target queuing time T_{queuing} may be determined in accordance with the following equation:

T_{Queuing}=Tₘₐₓ−(Thrptₑₛₜ−Thrptₘᵢₙ)*(Tₘₐₓ−Tₘᵢₙ)/(Thrptₘₐₓ−Thrptₘᵢₙ),

where:

Tₘₐₓ is an upper bound of the target queuing time. In some examples Tₘₐₓ may be set to a value (e.g., a predetermined value), e.g., to 100 ms.

Tₘᵢₙ is a lower bound of the target queuing time. In some examples Tₘᵢₙ may be set to a value (e.g., a predetermined value), e.g., to 10 ms.

Thrptₘₐₓ is an upper bound on the targeted range of the estimated throughput for the flow. In some examples, Thrptₘₐₓ may be set to a value (e.g., a predetermined value), e.g., equal to the peak rate of the UE in bits per second.

Thrptₘᵢₙ is a lower bound on the targeted range of the estimated throughput for the flow. In some examples, Thrptₘᵢₙ may be set to a value (e.g., a predetermined value), e.g., to 10 kBps.

Thrptₑₛₜ is an estimated throughput for the flow, in bits per second. In some examples, described in further detail below, the Node B may calculate an estimate of the throughput for the flow.

In a further aspect of the disclosure, the target queue length may correspond to the product of the estimated throughput of the flow Thrptₑₛₜ and the target queuing time at the Node B T_{queuing}, or Thrptₑₛₜ·T_{queuing} at the point 1008 on the line 1002 corresponding to these values.

Thus, based on the relationship between the target length of the Node B queue and the estimated throughput, in accordance with some aspects of the present disclosure, a target length of the queue may be selected in accordance with an estimated throughput of the flow from the Node B to the UE. In this way, the selection of the target queue length can maintain the target queuing delay T within a certain range (e.g., a predetermined range), e.g., between Tₘᵢₙ and Tₘₐₓ.

In one aspect of the present disclosure, the estimation of the flow throughput may be made by counting the total number of bytes transmitted over a relatively long period of time, and utilizing the average rate to estimate the throughput during a relatively short time, e.g., over a flow control interval. For example, the total number of bytes transmitted in 160 ms may be divided by 16 to estimate the throughput for a 10 ms flow control interval.

In an aspect of the present disclosure, an estimate of the flow throughput may be updated when the queue for the flow at the Node B is not empty. That is, if the queue is empty, the flow is generally stalled, and thus an estimate of the throughput may be skewed low if it incorporates the time when the flow is stalled.

Another exemplary method for estimating the flow throughput may include utilizing an IIR filter. Here, the filtering of the throughput over time utilizing the IIR filter can reduce one drawback of simple averaging, wherein if the fraction of time when the Node B queue is not empty is small, the flow throughput estimate may not be reliable. Of course, any other suitable method may be utilized to estimate the throughput within the scope of the present disclosure.

In another aspect of the present disclosure, the Node B may adapt the target queue length, or the upper bound on the target queue length, based on buffer underrun. In some examples, the Node B may adapt the target queue length, or the upper bound on the target queue length, based on buffer underrun every transmission time interval (TTI).

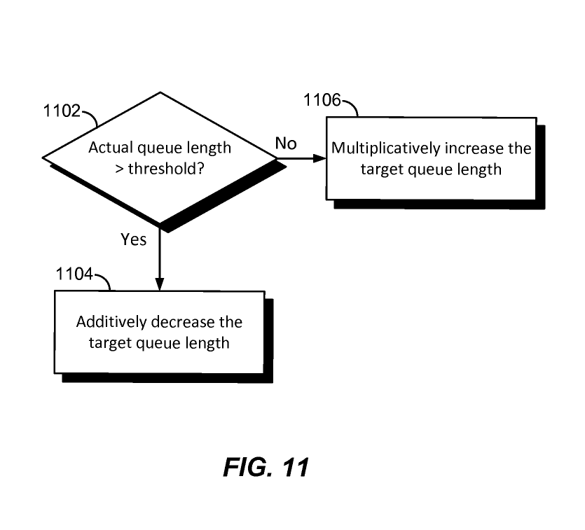

FIG. 11 is a simplified flow chart illustrating one example of a process for adapting the target queue length based on buffer underrun in accordance with an aspect of the present disclosure.

In block 1102, the process may compare the actual queue length at a given time with a certain threshold. For example, the threshold may be a fixed threshold configured to take a value such that buffer underrun is substantially mitigated. In one example, the threshold may be preconfigured for a length of 5 kilobytes.

Here, if the actual queue length is greater than the threshold, the process may proceed to block 1104, wherein the process may additively decrease the target queue length, or the upper bound on the target queue length. For example, a constant may be subtracted from the target queue length or the upper bound on the target queue length. In one example, the constant may take a value of 3 bytes. Of course, any suitable value may be utilized for the additive decrease in the target queue length or the upper bound on the target queue length.

If in block 1102 the process determines that the actual queue length is not greater than the threshold, the process may proceed to block 1106, wherein the process may multiplicatively increase the target queue length, or the upper bound on the target queue length. For example, a constant may be multiplied with the target queue length or the upper bound on the target queue length. In one example, the multiplicative increase factor may take a value of about 1.005. Of course, any suitable value greater than 1 may be utilized for the multiplicative increase factor for increasing the target queue length or the upper bound on the target queue length.

In this fashion, utilizing the exemplary process illustrated in FIG. 11 the target queue length can react quickly against buffer underrun with a multiplicative increase. However, once the queue is large enough that buffer underrun generally does not occur, then the targeted queue size may gradually decline utilizing an additive decrease to keep the size of the buffer small.

As mentioned above, in addition to the target queue length, the amount of data the Node B requests in the flow control message to the RNC may be based in part on one or more other factors, such as the current queue length, the priority of the MAC entity at the Node B, the status of the Node B as either a primary serving cell or a secondary serving cell for the UE corresponding to the flow, and an amount of data for UEs other than the UE corresponding to the flow, which are served by the Node B as a primary serving cell.

The priority of the MAC entity at the Node B can be a selection from any suitable priority from a separation of priorities in the system. For example, a priority for a Node B that is acting as a secondary serving cell for the UE corresponding to the flow may be dropped to a low number or even to zero if that Node B is acting as a primary serving cell for other UEs at the time the flow control message is generated. A priority may correspond to other factors as well, such as the type of data being requested, or any other suitable factor.

Returning now to FIG. 9, once the process determines the amount of data to request from the RNC, in block 908 the process may generate the flow control message including the amount of data to request from the RNC, and in block 910 the process may transmit the flow control message including the data request to the RNC. Here, the generating of the flow control message in block 908 may be performed by a processor such as the processor 104 illustrated in FIG. 1, and in some aspects of the disclosure, the processor 104 may reside within a Node B such as one of the Node Bs 704 or 706 illustrated in FIG. 8. Further, the transmitting of the flow control message from the Node B to the RNC in block 910 may be controlled by a processor 104, which may be the same processor or a different processor than the one utilized in block 906 to generate the flow control message. Further, the flow control message may be transmitted over an Iub interface, known to those of ordinary skill in the art, or over any suitable interface for communication between the Node B and the RNC.

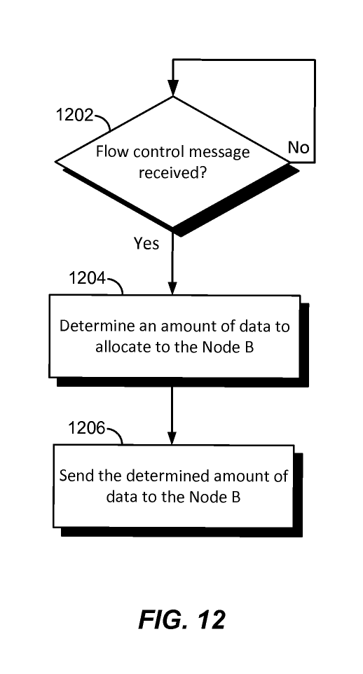

In a further aspect of the present disclosure, returning briefly to FIG. 8, the RNC 806 may receive the flow control message from the Node B 802 or 804 over the Iub interface, process the request, and respond. FIG. 12 is a simplified flow chart illustrating some of the aspects of the process performed at the RNC. Here, the RNC may include one or a plurality of Iub interfaces, and may be in communication with one or a plurality of Node Bs.

In general, the allocation and delivery of packets to the Node B over the Iub interface may be managed by a flow control protocol. Further, separate flow control protocols may act independently for each priority queue of each UE. That is, although the system may be a Multi-Point HSDPA system in which a plurality of Node Bs provide downlink data to the UE as primary and secondary serving cells, the flow control requests from each of the plural Node Bs may be processed at the RNC in a joint manner.

In block 1202, the process may determine whether a flow control message including a request for a certain amount of RLC data corresponding to an RLC flow for a UE has been received from a Node B, e.g., over the Iub interface. If no flow control message is received, the process may return to block 1202, potentially after a suitable delay.

If the process determines in block 1202 that a flow control message has been received from a Node B, the process may proceed to block 1204, where the process may determine an amount of data to allocate to the Node B, and accordingly allocate some portion of the RLC data to the corresponding Node B. In block 1206, the process may send the determined amount of data to the Node B in response to the flow control message.

In some aspects of the disclosure, the process illustrated in FIG. 12 may correspond to flow control messages received from plural Node Bs, e.g., acting as a primary serving cell and a secondary serving cell for a particular UE in a Multi-Point HSDPA system.

The determination in block 1204 of the amount of data to allocate and send to the Node B in response to the flow control message may be made in accordance with any combination of one or more factors such as, but not necessarily limited to: an amount of data requested by the Node B, an amount of data requested by a disparate Node B, a priority of the Node B, a size of batches of data to be sent to the Node B, and whether the target queue length set by the Node B was met.

That is, in one aspect of the present disclosure, the allocation of RLC data for an RLC flow for a UE can be based in part on the amount of data requested by the Node B. In general, the amount of data allocated to the Node B may be any function of the amount of data that the Node B requested. In one example, the RNC may send data to each Node B in proportion to its request.

An allocation to Node Bs in proportion to the Node Bs' requests may be appropriate when the amount of data at the RNC for the UE served by the Node Bs is less than the total amount of data requested from both Node Bs, and the secondary serving cell (or cells) does not have any primary users with data. As compared to a flow control algorithm that sends data in response to incoming requests in a “greedy” manner, known to those skilled in the art, providing the data to the Node Bs in proportion to their request can provide for reduced skew when the data arrives at the UE when there is only a small amount of data in the RNC buffer, e.g., during a TCP slow start.

In another aspect of the present disclosure, the allocation of RLC data for an RLC flow for a UE can be based in part on an amount of data requested by a disparate Node B. For example, referring again to FIG. 8, the Node B 802 sending the flow control message may be a primary serving cell with respect to a UE in a Multi-Point HSDPA system. Here, the disparate Node B 804 may act as a secondary serving cell with respect to the same UE in the Multi-Point HSDPA system. In this case, the allocation to the primary serving cell 802 can be determined jointly, based in part on the amount of data requested by the secondary serving cell 804. For example, if the primary serving cell 802 and the secondary serving cell 804 each request the same amount of data, the RNC 806 may determine to allocate a different amount of data, e.g., a larger amount, to the primary serving cell 802. However, if the secondary serving cell 804 requests a smaller amount of data than the primary serving cell, the RNC 806 may determine to allocate the same amount of data to the primary serving cell 802 as it requested. Of course, any other suitable relationship between the amount of data requested by the disparate Node B 804 and the amount of data allocated to the requesting Node B 802 may be utilized within the scope of the present disclosure.

In another aspect of the present disclosure, the allocation of RLC data for an RLC flow for a UE can be based in part on a priority of the Node B sending the request. In one example in accordance with some aspects of the disclosure, the primary serving cell may be given a higher priority than the secondary serving cell.

In some aspects of the present disclosure, a priority may be assigned to a Node B for a particular flow control message in accordance with an amount of data the Node B is providing to other, disparate UEs served by that Node B as a primary serving cell

For example, referring once again to FIG. 6, assume that the Node B 604 sending a flow control message to request data is acting as a secondary serving cell in a Multi-Point HSDPA system serving a UE 610. Here, this Node B 604 may additionally be serving other UEs, e.g., UEs 618, 620, and 622 as a primary serving cell. In the illustrated example, UEs 618 and 620 may be legacy UEs utilizing HSDPA service where the Node B 604 is their only serving cell, while UE 622 may be a Multi-Point HSDPA UE wherein the Node B 604 is its primary serving cell, and a disparate Node B 624 acts as its secondary serving cell.

In this instance, if the Node B 604 provides service to the UE 610 for the flow corresponding to the flow control message as the secondary serving cell, the performance of the other UEs 618, 620, and 622 utilizing this Node B 604 as their primary serving cell may have their performance degraded. This may adversely affect the system-wide fairness.

Here, the Node B 604 may be assigned a reduced priority level based on its status as a secondary serving cell for the UE 610 and its status as a primary serving cell for one or more disparate UEs, e.g., UEs 618, 620, and 622.

In one example in accordance with some aspects of the present disclosure, the reduced priority may mean that no RLC data is assigned by the RNC to the Node B 604 in this instance. That is, in an aspect of the present disclosure, whenever the RNC queue for any UEs being served by the Node B as a primary serving cell is not empty, the RNC may ignore flow control messages from the Node B requesting data for the UE as a secondary serving cell, and only respond to such messages from that UE's primary serving cell (here, corresponding to Node B 602).

In another aspect of the present disclosure, the allocation of RLC data for an RLC flow for a UE can be based in part on a batch size. That is, for sending to the Node B, the allocated data may be divided into batches that include a fractional portion of the RLC data. Here, the batch size may be different for each Node B, or may be the same for each Node B. Further, the batch size may be fixed or configurable based on any suitable factors in accordance with the specifics of a particular implementation.

Here, the amount of RLC data allocated to a particular Node B may be a function of the batch size, for example being an integer multiple of the batch size. In another example, larger batch sizes may be more conducive to larger allocations of data, or smaller batch sizes may be utilized for larger allocations of data, for reasons specific to a particular implementation.

Returning now to FIG. 12, upon determining the amount of data to send to the Node B in block 1204, in block 1206 the process may send the determined amount of data to the Node B. In an example utilizing a Multi-Point HSDPA system with a primary serving cell and a secondary serving cell each requesting data for the same UE, when the RNC sends the allocated data to the plural Node Bs, in addition to determining how much data to allocate to each Node B, in block 1206 the RNC also generally determines which portions of the data to send to each Node B.

As described above with respect to FIG. 7, the RLC sublayer at the RNC 702 generally provides the data to the MAC-d sublayer at the RNC 702. Here, MAC-d PDUs generated by the RNC 702 may be sent to a MAC entity, e.g., the MAC-ehs sublayer at the Node B 704 or 706, in batches, in HS-DSCH data frames over the Iub interface. The Node B 704 or 706 may then buffer the PDUs until they are scheduled and successfully transmitted over the air interface to the UE.

In an aspect of the present disclosure, the batches may be less than or equal to the total allocation to that Node B. For example, assume that 30 RLC PDUs are in the RNC 702 for the UE 708, and assume that the RNC 702 has determined to allocate 10 packets to a first Node B 704, and 10 packets to a second Node B 706. Here, the RNC 702 may divide the RLC PDUs in the RNC into batches of 10 packets, with a first batch to be sent to the first Node B 704, and a second batch to be sent to the second Node B 706. That is, here each batch may include some fraction of the RLC data to be allocated to the Node Bs.

In some aspects of the present disclosure, as discussed above the amount of the RLC data that is allocated to the Node Bs may be a function of the batch size. For example, in the example described above, the amount of RLC data allocated to each Node B is equal to the batch size of 10 packets. Of course, in other examples, the amount of RLC data allocated to each Node B may be any integer multiple of the batch size.

Here, packets 1 to 10 may be sent to the first Node B, and packets 11 to 20 may be sent to the second Node B. In this example, assuming the same channel conditions at the two serving cells, because packets 1-10 are transmitted in order from the first Node B at the same time as packets 11-20 are transmitted in order from the second Node B, the order of arrival of the packets at the UE is 1, 11, 2, 12, 3, 13, . . . 10, 20. Here, the maximum skew at the UE is 10 packets. That is, the gap in between received packets, e.g., packets 1 and 11, is 10 packets wide.

In another aspect of the present disclosure, the batches or packets may be sent to each Node B in a staggered fashion, e.g., alternating in time batch-by-batch or packet-by-packet. For example, odd-numbered packets may be sent to the first Node B, while even-numbered packets may be sent to the second Node B. In this example, assuming the same channel conditions at the serving cells, the order of arrival of the packets at the UE is 1, 2, 3, . . . 19, 20. That is, there is no skew at the UE. However, in this example, if the channel conditions change at one of the Node Bs, the number of gaps when utilizing packet staggering may be higher than the number of gaps when sending the packets in batches.

For example, when sending the packets in batches, if the first Node B becomes stalled, the order of arrival of the packets at the UE is 11, 12, 13, . . . 20. Here, there is only one gap. On the other hand, when sending the packets utilizing packet staggering, if the first Node B becomes stalled, the order of arrival of the packets at the UE is 2, 4, 6, . . . 20. Here, there are 10 gaps. More gaps may increase the burden in the uplink feedback, since the RLC Status PDU from the UE, which reports these gaps, may become larger. Of course, this example utilized a batch size of 1 packet, while various examples in accordance with the present disclosure may utilize any suitable batch size for staggering.

When utilizing batch staggering, the size of the batch may be determined by taking into account certain tradeoffs. That is, a larger batch size may reduce the number of gaps when the packets are received at the UE, while a smaller batch size may reduce the skew when the packets are received at the UE but may increase the number of gaps. Of course, any suitable batch size may be utilized within the scope of the present disclosure.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
determining an estimated throughput of a flow from a Node B to a UE;
selecting a target length of a queue for the flow at the Node B in accordance with the estimated throughput of the flow, such that a target queuing delay is maintained within a predetermined range; and
requesting an amount of RLC data to be allocated to a MAC entity corresponding to the Node B.

2. The method of claim 1, wherein the determining of the estimated throughput of the flow is performed only when the queue for the flow at the Node B is not empty.

3. The method of claim 1, wherein the target queuing delay is a function of the estimated throughput of the flow.

4. The method of claim 1, wherein the amount of the RLC data requested is a function of at least one of a priority of the MAC entity, the target length of the queue for the flow, or a current length of the queue for the flow.

5. The method of claim 1, wherein the amount of the RLC data requested is a function of whether a cell corresponding to the Node B serves the UE as a primary serving cell or a secondary serving cell.

6. The method of claim 1, wherein the amount of the RLC data requested is a function of an amount of data for at least one UE other than the UE, wherein the at least one UE is served by a cell corresponding to the Node B as a primary serving cell.

7. A method of wireless communication, comprising:
receiving a first request from a first MAC entity for a first amount of RLC data corresponding to an RLC flow for a UE, and a second request from a second MAC entity for a second amount of the RLC data;
allocating a first portion of the RLC data to the first MAC entity based in part on the first request, and based in part on a priority of the first MAC entity; and
allocating a second portion of the RLC data to the second MAC entity based in part on the second request, and based in part on a priority of the second MAC entity.

8. The method of claim 7, wherein the allocating of the first portion of the RLC data is further based in part on the second request.

9. The method of claim 7,
wherein the first MAC entity corresponds to a primary serving cell in a Multi-Point HSDPA network; and
wherein the second MAC entity corresponds to a secondary serving cell in the Multi-Point HSDPA network.

10. The method of claim 9, further comprising:
assigning the priority to the second MAC entity in accordance with an amount of data for at least one UE other than the UE, wherein the at least one UE is served by a cell corresponding to the second MAC entity as a primary serving cell.

11. The method of claim 7, further comprising:
sending the first portion of the RLC data to the first MAC entity; and
sending the second portion of the RLC data to the second MAC entity,
wherein the allocating of the first portion of the RLC data and the allocating of the second portion of the RLC data comprise:
dividing the first portion of RLC data into a first plurality of fractions; and
dividing the second portion of RLC data into a second plurality of fractions,
wherein a size of the first portion allocated to the first MAC entity corresponds to a size of one of the first plurality of fractions, and
wherein a size of the second portion allocated to the second MAC entity corresponds to a size of one of the second plurality of fractions.

12. The method of claim 11, wherein the allocating of the first portion of the RLC data and the allocating of the second portion of the RLC data further comprise alternating between allocating one of the first plurality of fractions and allocating one of the second plurality of fractions.

13. An apparatus for wireless communication, comprising:
means for determining an estimated throughput of a flow from a Node B to a UE;
means for selecting a target length of a queue for the flow at the Node B in accordance with the estimated throughput of the flow, such that a target queuing delay is maintained within a predetermined range; and
means for requesting an amount of RLC data to be allocated to a MAC entity corresponding to the Node B.

14. The apparatus of claim 1, wherein the means for determining the estimated throughput of the flow is configured to determine the estimated throughput only when the queue for the flow at the Node B is not empty.

15. The apparatus of claim 13, wherein the target queuing delay is a function of the estimated throughput of the flow.

16. The apparatus of claim 13, wherein the amount of the RLC data requested is a function of at least one of a priority of the MAC entity, the target length of the queue for the flow, or a current length of the queue for the flow.

17. The apparatus of claim 13, wherein the amount of the RLC data requested is a function of whether a cell corresponding to the Node B serves the UE as a primary serving cell or a secondary serving cell.

18. The apparatus of claim 13, wherein the amount of the RLC data requested is a function of an amount of data for at least one UE other than the UE, wherein the at least one UE is served by a cell corresponding to the Node B as a primary serving cell.

19. An apparatus for wireless communication, comprising:
means for receiving a first request from a first MAC entity for a first amount of RLC data corresponding to an RLC flow for a UE, and a second request from a second MAC entity for a second amount of the RLC data;
means for allocating a first portion of the RLC data to the first MAC entity based in part on the first request, and based in part on a priority of the first MAC entity; and
means for allocating a second portion of the RLC data to the second MAC entity based in part on the second request, and based in part on a priority of the second MAC entity.

20. The apparatus of claim 19, wherein the means for allocating the first portion of the RLC data is configured to base an amount of the first portion of data based in part on the second request.

21. The apparatus of claim 19,
wherein the first MAC entity corresponds to a primary serving cell in a Multi-Point HSDPA network; and
wherein the second MAC entity corresponds to a secondary serving cell in the Multi-Point HSDPA network.

22. The apparatus of claim 21, further comprising:
means for assigning the priority to the second MAC entity in accordance with an amount of data for at least one UE other than the UE, wherein the at least one UE is served by a cell corresponding to the second MAC entity as a primary serving cell.

23. The apparatus of claim 19, further comprising:
means for sending the first portion of the RLC data to the first MAC entity; and
means for sending the second portion of the RLC data to the second MAC entity,
wherein the means for allocating the first portion of the RLC data and the means for allocating the second portion of the RLC data comprise:
means for dividing the first portion of RLC data into a first plurality of fractions; and
means for dividing the second portion of RLC data into a second plurality of fractions,
wherein a size of the first portion allocated to the first MAC entity corresponds to a size of one of the first plurality of fractions, and
wherein a size of the second portion allocated to the second MAC entity corresponds to a size of one of the second plurality of fractions.

24. The apparatus of claim 23, wherein the means for allocating the first portion of the RLC data and the means for allocating the second portion of the RLC data are configured to alternate between allocating one of the first plurality of fractions and allocating one of the second plurality of fractions.

25. An apparatus for wireless communication, comprising:
a processing system; and
a memory coupled to the processing system,
wherein the processing system is configured to:
determine an estimated throughput of a flow from a Node B to a UE;
select a target length of a queue for the flow at the Node B in accordance with the estimated throughput of the flow, such that a target queuing delay is maintained within a predetermined range; and
request an amount of RLC data to be allocated to a MAC entity corresponding to the Node B.

26. The apparatus of claim 25, wherein the determining of the estimated throughput of the flow is performed only when the queue for the flow at the Node B is not empty.

27. The apparatus of claim 25, wherein the target queuing delay is a function of the estimated throughput of the flow.

28. The apparatus of claim 25, wherein the amount of the RLC data requested is a function of at least one of a priority of the MAC entity, the target length of the queue for the flow, or a current length of the queue for the flow.

29. The apparatus of claim 25, wherein the amount of the RLC data requested is a function of whether a cell corresponding to the Node B serves the UE as a primary serving cell or a secondary serving cell.

30. The apparatus of claim 25, wherein the amount of the RLC data requested is a function of an amount of data for at least one UE other than the UE, wherein the at least one UE is served by a cell corresponding to the Node B as a primary serving cell.

31. An apparatus for wireless communication, comprising:
a processing system; and
a memory coupled to the processing system,
wherein the processing system is configured to:
receive a first request from a first MAC entity for a first amount of RLC data corresponding to an RLC flow for a UE, and a second request from a second MAC entity for a second amount of the RLC data;
allocate a first portion of the RLC data to the first MAC entity based in part on the first request, and based in part on a priority of the first MAC entity; and
allocate a second portion of the RLC data to the second MAC entity based in part on the second request, and based in part on a priority of the second MAC entity.

32. The apparatus of claim 31, wherein the allocating of the first portion of the RLC data is further based in part on the second request.

33. The apparatus of claim 31,
wherein the first MAC entity corresponds to a primary serving cell in a Multi-Point HSDPA network; and
wherein the second MAC entity corresponds to a secondary serving cell in the Multi-Point HSDPA network.

34. The apparatus of claim 33, wherein the processing system is configured to:
assign the priority to the second MAC entity in accordance with an amount of data for at least one UE other than the UE, wherein the at least one UE is served by a cell corresponding to the second MAC entity as a primary serving cell.

35. The apparatus of claim 31, wherein the processing system is configured to:
send the first portion of the RLC data to the first MAC entity; and
send the second portion of the RLC data to the second MAC entity,
wherein the allocating of the first portion of the RLC data and the allocating of the second portion of the RLC data comprise:
dividing the first portion of RLC data into a first plurality of fractions; and
dividing the second portion of RLC data into a second plurality of fractions,
wherein a size of the first portion allocated to the first MAC entity corresponds to a size of one of the first plurality of fractions, and
wherein a size of the second portion allocated to the second MAC entity corresponds to a size of one of the second plurality of fractions.

36. The apparatus of claim 35, wherein the allocating of the first portion of the RLC data and the allocating of the second portion of the RLC data comprise alternating between allocating one of the first plurality of fractions and allocating one of the second plurality of fractions.

37. A computer program product, comprising:
a computer-readable medium comprising:
instructions for causing a computer to determine an estimated throughput of a flow from a Node B to a UE;
instructions for causing a computer to select a target length of a queue for the flow at the Node B in accordance with the estimated throughput of the flow, such that a target queuing delay is maintained within a predetermined range; and
instructions for causing a computer to request an amount of RLC data to be allocated to a MAC entity corresponding to the Node B.

38. The computer program product of claim 37, wherein the instructions for causing a computer to determine the estimated throughput of the flow are configured to determine the estimated throughput only when the queue for the flow at the Node B is not empty.

39. The computer program product of claim 37, wherein the target queuing delay is a function of the estimated throughput of the flow

40. The computer program product of claim 37, wherein the amount of the RLC data requested is a function of at least one of a priority of the MAC entity, the target length of the queue for the flow, or a current length of the queue for the flow.

41. The computer program product of claim 37, wherein the amount of the RLC data requested is a function of whether a cell corresponding to the Node B serves the UE as a primary serving cell or a secondary serving cell.

42. The computer program product of claim 37, wherein the amount of the RLC data requested is a function of an amount of data for at least one UE other than the UE, wherein the at least one UE is served by a cell corresponding to the Node B as a primary serving cell.

43. A computer program product, comprising:
a computer-readable medium comprising:
instructions for causing a computer to receive a first request from a first MAC entity for a first amount of RLC data corresponding to an RLC flow for a UE, and a second request from a second MAC entity for a second amount of the RLC data;
instructions for causing a computer to allocate a first portion of the RLC data to the first MAC entity based in part on the first request, and based in part on a priority of the first MAC entity; and
instructions for causing a computer to allocate a second portion of the RLC data to the second MAC entity based in part on the second request, and based in part on a priority of the second MAC entity.

44. The computer program product of claim 43, wherein the allocating of the first portion of the RLC data is further based in part on the second request.

45. The computer program product of claim 43,
wherein the first MAC entity corresponds to a primary serving cell in a Multi-Point HSDPA network; and
wherein the second MAC entity corresponds to a secondary serving cell in the Multi-Point HSDPA network.

46. The computer program product of claim 45, further comprising:
instructions for causing a computer to assign the priority to the second MAC entity in accordance with an amount of data for at least one UE other than the UE, wherein the at least one UE is served by a cell corresponding to the second MAC entity as a primary serving cell.

47. The computer program product of claim 43, further comprising:
instructions for causing a computer to send the first portion of the RLC data to the first MAC entity; and
instructions for causing a computer to send the second portion of the RLC data to the second MAC entity,
wherein the instructions for causing a computer to allocate the first portion of the RLC data and the instructions for causing a computer to allocate the second portion of the RLC data comprise:
instructions for causing a computer to divide the first portion of RLC data into a first plurality of fractions; and
instructions for causing a computer to divide the second portion of RLC data into a second plurality of fractions,
wherein a size of the first portion allocated to the first MAC entity corresponds to a size of one of the first plurality of fractions, and
wherein a size of the second portion allocated to the second MAC entity corresponds to a size of one of the second plurality of fractions.

48. The computer program product of claim 47, wherein the instructions for causing a computer to allocate the first portion of the RLC data and the instructions for causing a computer to allocate the second portion of the RLC data are configured to alternate between allocating one of the first plurality of fractions and allocating one of the second plurality of fractions.
